(19) United States
(12) Patent Application Publication
(10) Pub. No.: US 2021/0256094 A1
(43) Pub. Date: Aug. 19, 2021

(54) SYSTEMS AND METHODS FOR DOCUMENT MANAGEMENT CLASSIFICATION, CAPTURE AND SEARCH

(71) Applicant: JPMorgan Chase Bank, N.A., New York, NY (US)

(72) Inventors: Harsh Benara, Edison, NJ (US); Anant Verma, Berkeley Heights, NJ (US); Graham Robertson, Glasgow (GB); Shambhu Pandey, Princeton, NJ (US); David MacKenzie, Glasgow (GB); Amol Bakshi, Newark, DE (US)

(21) Appl. No.: 15/649,544

(22) Filed: Jul. 13, 2017

Related U.S. Application Data
(60) Provisional application No. 62/361,917, filed on Jul. 13, 2016.
(60) Provisional application No. 62/397,770, filed on Sep. 21, 2016.

(51) Int. Cl. G06F 17/30; G06F 17/24

(52) U.S. Cl. CPC G06F 17/30011; G06F 17/30707; G06F 17/248; G06F 17/30613; G06F 17/30657

(57) ABSTRACT

Systems and methods for document management classification, capture and search are disclosed. In one embodiment, a system for document management may include a document taxonomy library comprising a plurality of document taxonomies; a document create module comprising a document metadata repository and a document template/clause repository; a document capture module comprising a metadata repository, an image repository, and a document capture workflow; and a document communicate module comprising an extracted metadata repository. In one embodiment, the document create module creates a document using a document taxonomy from the document taxonomy library, the document metadata repository, and the template clause/repository; the document capture module captures metadata from the document based on a document taxonomy associated with the document; and the document communicate module stores extracted metadata from the document in the extracted metadata repository.

### RELATED APPLICATIONS

This application claims priority to U.S. Provisional Patent Application Ser. No. 62/361,917, filed Jul. 13, 2016, and to U.S. Provisional Patent Application Ser. No. 62/397,770, filed Sep. 21, 2016, the disclosure of each of which is hereby incorporated, by reference, in its entirety.

### BACKGROUND OF THE INVENTION

### 1. Field of the Invention

The present disclosure generally relates to systems and methods for document management functions including taxonomy (classification), indexing, capture and search.

### 2. Description of the Related Art

In a content management system, the goal is to capture metadata on a defined set of documents. Generally these metadata definitions are incorporated within the framework and build explicitly for each type or classification of the document. A user interface is additionally created to capture the associated metadata for each individual classification. The software delivery generally requires explicit knowledge of document titles and bespoke efforts for each.

### SUMMARY OF THE INVENTION

Systems and methods for document management classification, capture and search are disclosed. In one embodiment, a method for document creation may include (1) at least one computer processor receiving an identification of a document type; (2) the at least one computer processor retrieving a taxonomy for the document type; (3) the at least one computer processor receiving a plurality of selections for document attributes based on the taxonomy; (4) the at least one computer processor creating the document based on the selected attributes; and (5) the at least one computer processor capturing metadata from the document.

In another embodiment, a system for document management may include a document taxonomy library comprising a plurality of document taxonomies; a document create module comprising a document metadata repository and a document template/clause repository; a document capture module comprising a metadata repository, an image repository, and a document capture workflow; and a document communicate module comprising an extracted metadata repository. In one embodiment, the document create module creates a document using a document taxonomy from the document taxonomy library, the document metadata repository, and the template clause/repository; the document capture module captures metadata from the document based on a document taxonomy associated with the document; and the document communicate module stores extracted metadata from the document in the extracted metadata repository.

In one embodiment, the document communicate module may provide document searching using the extracted metadata.

In one embodiment, the system may further include a downstream process that interacts with the document communicate module.

According to another embodiment, a method for document metadata capture may include (1) at least one computer processor receiving an identification of a document required by a business process; (2) the at least one computer processor interpreting and rendering, on a display, a user interface related to the document; (3) the at least one computer processor storing metadata related to the document; (4) the at least one computer processor splitting a first list of data points arbitrarily based on a second list of data points; (5) the at least one computer processor identifying at least one relationship in the document; and (6) the at least one computer processor communicating the document to at least one of a second computer process, a process, a storage, and an individual.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for document management classification, capture and search according to one embodiment.

FIG. 2 depicts a method for document management classification, capture and search according to one embodiment.

FIG. 3 depicts a high-level architecture for document management according to one embodiment.

FIG. 4 depicts an architecture of a document capture platform is disclosed according to one embodiment.

FIG. 5 depicts an example of a taxonomy is provided according to one embodiment.

FIG. 6 depicts an end-to-end process flow of a capture process according to one embodiment.

FIG. 7 depicts an example digitization process according to one embodiment.

FIG. 8 depicts a search architecture according to one embodiment.

### DETAILED DESCRIPTION OF PREFERRED EMBODIMENTS

Embodiments disclosed herein related to systems and methods for document management classification, capture and search.

Most content and document management systems aim to provide workflow and metadata around capture but lack an ability to define these business enabled documents. Additionally, these systems treat documents as individual images, which impacts the understanding and processing of contractual agreements that organizations, such as financial institutions, enter into with their clients.

A lack of a consistent approach to document management often leads to multiple repositories and document definitions. These result is that different part of an organization have their own repositories with specific information, definitions, processes and/or technology. This may impact the ability of the organization to meet regulatory and/or client demands for contractual agreements and may increase, for example, financial and reputation risk.

Embodiments disclosed herein provide some or all of a single unified end-to-end solution for capturing key metadata for an organization's documents, a simplified definition of contractual and client documents, a common place to define metadata that needs to be captured for each title, a rule-based automated framework that may render a user interface to capture document meta data and associated images, a search feature that uses, for example, client documentation, document metadata, and/or static reference data, and returns information from multiple systems to a user, and a digitization platform to digitize the paper to electronic medium.

Embodiments may automatically react to a change in a document definition, and may allow storage and capture without coding. Embodiments may be pattern-based that may be used as long as the new data adheres to the defined patterns.

Embodiments are directed to a document management architecture, system, and method comprising document taxonomy, indexing, storage and search, coupled with end-to-end data management and distribution.

It may provide some or all of the following advantages: (1) a consolidated technical solution that provides organization wide document management services; simplified document management capabilities; a centrally managed platform/services; the consolidation of technology services with operational capabilities; agility (e.g., the architecture, system, and method may quickly adapt to new business requirements and obligations by managing changes proactively and making information readily available to assess risk in the event of major crises); risk mitigation and control (e.g., may improve data quality and controls to reduce financial, reputational and compliance risks by supporting internal and external audit, may support a common taxonomy, core metadata, and document specific metadata, and may enable transparency of end-to-end client documentation lifecycle); operational efficiency (e.g., may promote a common and shared understanding through single document taxonomy using document metadata to standardize documents and make them more accessible, and by the consolidation of common documentation functions).

Embodiments may include a document taxonomy engine or module, dynamic document capture engine or module, and a search engine or module.

A document taxonomy may specify a common consistent ontology for documents to be captured across various parts of an organization (e.g., lines of business, business units, etc.) and systems. A taxonomy may provide a mechanism to define data in a consistent fashion across multiple parts of an organization, ensure standards across these definitions, provide technology interface for seamless integration, and provide a common place for defining business rules applicable for this data set.

In one embodiment, a multiple-level taxonomy may be used in order to logically categorize, search for and retrieve documents across an organization. For example, a first level may be the broadest category, and a nth level may be the narrowest (most granular) category. A n+1 level may be used which may represent the instance of a specific document, denoted by a Document Title.

In one embodiment, each document may map into the taxonomy at the nth level, also known as the Document Type

Any suitable number of taxonomy levels may be provided as is necessary and/or desired.

In one embodiment, a document classification may be used to provide a classification of documents based on pre-determined criteria that is used for identification, analysis and retrieval of information that may be associated with client-related documents.

In one embodiment, a document metadata definition may define metadata attributes for a document, including, for example, core metadata (e.g., mandatory attributes that should be captured for all documents that are captured) and document specific metadata (e.g., these attributes relate to a particular document over and above what the core metadata attributes stipulate. The extended metadata is arranged as groups (e.g., clauses or metadata groups) and attributes).

In one embodiment, a dynamic document metadata/image capture platform, engine, or module may be used. A document capture interface system may facilitate the capture of key data points, relating to documents, based on the document taxonomy. It may also provide document storage, automated content extraction, image acquisition, quality control, workflow, tagging and management. It may further follow an organization's policies and standards, for example, for data driven entitlements and data segregation.

In one embodiment, the platform may provide basic technology services. For example, it may provide “Technology as a Service” for document management related functions (e.g., store, OCR, retention, etc.). In another embodiment, it may provide enriched document utility and distribution, such as the enforcement of standards and controls to enable cross business unit and/or organization usage of document data. In another embodiment, it may provide end-to-end managed services by providing managed services for processing document data, along with ownership of business processes.

In one embodiment, the document capture interface system may follow a taxonomy driven design and may adapt the user interface according to the information specified in the document's taxonomy. This may add flexibility that allows new metadata and titles to be added in a very short time frame. Embodiments enable a fully automated process where document data can be defined in taxonomy, document instances captured within the platform and search enabled on these without any technology build or involvement.

In one embodiment, the document capture interface system may use a user interface component, called a “widget” The widget may perform a specific business function and may communicate with other widgets using messaging. For example, a widget may be a web component wrapped in an HTML iframe. This component may be served from any web domain and may be independently scaled both horizontally and vertically.

In embodiments, a rules driven service may allow business rules, policies, etc. to be automatically applied to a document indexing process. Given the complexities around legal/contractual documents, the engine may decipher what is needed to capture from a given document, based on user input and/or pre-defined meta data.

In one embodiment, mechanisms for software system for entering data where the data can be duplicated, split, repeated or pertains to a variably nested hierarchy are disclosed. For example, when users are asked to enter unstructured data from a physical document into an online form they often find that the screens or data model is insufficient to capture all the data satisfactorily. This usually happens because the data might appear multiple times in the document and for a variety of ad-hoc purposes, the data might be tagged for a specific purpose or it might be nested in a hierarchy that might be structured differently for each document. In one embodiment, data points may be split based, for example, another list of data points. For example; a data point might have a data point for the number of people working at in an office. However, there might be five offices, which would require the user to enter the data point five times. In embodiments, the user could split the data point five times, once for each office location.

As another example, a user may have two companies in the same office, but may need to list the numbers separately. In this case the user would split the data point by company. Traditional hierarchal data modeling would force the designer to decided upfront which the order in which data points can be nested. Embodiments store additional information, controlled by the user (called a split definition), that describes how the data can be split. Each split data point may be tagged with a unique repeat that describes the context of that split. Data may be stored with the field name, the repeat information and the split definition.

In one embodiment, a document search and distribution engine is provided. In embodiments, a mechanism for providing consistent data searches across multiple systems is disclosed, with enhanced search capabilities and ability to view images attached to these documents. This enables searching for data and patterns which may not have been indexed in core systems but are vital for processes (e.g., business processes) to react. Embodiments provide a consolidated view of clients in a centralized location without the need of re-keying and merging multiple technology applications or changing complex business processes.

In one embodiment, a variety of upstream sources may send messages (e.g., XML messages) containing documents' metadata to the document search and distribution engine. This may include, for example, core metadata, extended metadata, and information about images associated with the documents. In one embodiment, core metadata is metadata having a structure that is consistent across all types of document. Examples of core metadata include the parties to an agreement; the Document Management System that sent the document; confidentiality rating; governing law; expiry date; etc.

Extended metadata may follow a taxonomy may be arranged within clauses that have been defined for each type of document. This may be contained within an extensible XML format, which allows changes to be made to the taxonomy without it requiring a new XML schema to be published.

The information about the images associated with the document may allow the images to be retrieved from the image repository at a later point.

In one embodiment, the messages may be stored as documents within a repository, such as a MarkLogic repository. Various indexes exist across this repository to allow efficient searches to be carried out against both core and extended metadata.

In one embodiment, a search API may be provided to facilitate searching. The API may be called by other applications, allowing them to fully integrate document searching into their own functionality.

In one embodiment, each search may return, for example, the XML of a “page” of matching documents (the size of the pagination may be parameterized in the API), as well as information about filters that can be used to narrow the results down to a smaller set of documents.

In one embodiment, a grammar may be used to allow more complex searches to be carried out. This allows multiple search criteria to be specified in a way that Business users can easily enter, such as “Change in Control”=Mutual AND “Counterparty required to provide collateral”=Yes. Moreover, type-ahead functionality helps ensure that queries can be entered quickly and accurately.

In one embodiment, a digitization program may extract the content from documents, and the search engine may tore that along with the document's metadata, and use that content in its search. In one embodiment, the document indexing permits quick searching for documents containing a particular word, phrase, or combination of words or phrases near each other. For example, a single click from the search GUI may allow a user to see the corresponding document image, which may be retrieved from the relevant image repository.

According to embodiments, a system and method for document management classification, capture and search may include a document taxonomy, indexing, storage and search, coupled with end-to-end data management and distribution. Embodiments may include a document taxonomy platform/module, a dynamic document metadata/image capture platform/module, and a search platform/module.

In one embodiment, a document taxonomy may specify a common consistent ontology for documents to be captured across, for example, various systems. The document taxonomy provides a mechanism to define data in a consistent fashion across multiple systems, to set standards across these definitions, to provide a technology interface for seamless integration and a common place for defining, for example, business rules applicable for this data set.

In one embodiment, a dynamic document metadata/image capture platform may bring together a number of technologies to facilitate capture of key data points, relating to documents, based on, for example, a document taxonomy. It may also provide document storage, automated content extraction, image acquisition, quality control, workflow, tagging and management.

In one embodiment, the platform allows multiple custom business implementations to be built from an available pool of services and user interface widgets. It follows a taxonomy-driven design and adapts the user interface according to the information specified in the document's taxonomy.

In one embodiment, the system may be accessed and/or distributed in varying levels of sophistication. For example, basic technology services may be provided, in which technology may be provided as a service for document management related functions (e.g., store, OCR, retention, etc.). Enriched document utility and distribution maybe provided, in which standards and controls to enable cross system/business usage of document data may be used. End-to-end managed services may be provided, in which managed services for processing document data, along with ownership of business processes may be used.

Embodiments may use a rules driven service that allows, for example, business and other rules to be applied automatically to document indexing process. For example, given the complexities around legal/contractual documents, the engine may decipher what is needed to capture on a given document, both based on user input and pre-defined meta data.

In one embodiment, the flexibility of the system allows new metadata and titles to be added in a very short time frame. The system enables a fully automated process where document data can be defined in taxonomy, document instances captured within the platform and search enabled on these without any technology build or involvement.

In one embodiment, embodiments may provide document search and distribution. For example, a mechanism for providing consistent data searches across multiple systems, with enhanced search capabilities and ability to view images attached to these documents is provided. This may enable, for example, searching for data and patterns that may not have been indexed in core systems, but are important for other functions and processes.

In one embodiment, a consolidated view of clients in a centralized location without the need of re-keying and merging multiple technology applications or changing complex business processes may be provided.

Embodiments may provide technological improvements, including consolidated technical solution—business-wide document management services (e.g., simplified document management capabilities; centrally managed platform/services, etc.); consolidation of technology services with operational capabilities; business agility (e.g., system and methods quickly adapt to new business requirements and obligations, etc.); proactive management of business changes; information may be readily available to assess risk in the event of a crisis; risk mitigation and control (e.g., improve data quality and controls to reduce financial, reputational and compliance risks, such as supporting internal and external audits, the use of common taxonomy, core metadata, and document specific metadata enable transparency of end-to-end client documentation lifecycle, etc.); operational efficiency (e.g., common and shared understanding through single document taxonomy, document metadata makes documents more standardized and accessible, economies of scale due to consolidation of common documentation functions, etc.).

In one embodiment, the taxonomy may be an organization or business drive taxonomy. It may define and distribute document metadata definitions, including that specific to an industry, organization or document type. It may implement business and/or systematic checks that a client wants to implement during the data capture process. It may include collect desired enumerations during capture, and may publish this for downstream consumption, including semantic or syntactic checks on document titles.

Embodiments provide a flexible framework to represent any document title, and may cover a variety of document types. For example, for a financial services-based organization, this may include contractual, legal, constitutional, trading, party and regulatory relationships. Other types of organizations and institutions may include different document types.

In one embodiment, a document capture interface system may be based on a generic framework, and may capture document metadata via a user defined taxonomy. It may provide the capability to store images and metadata in a flexible manner. In one embodiment, the document capture interface system may be “self-subscribing” in that new document titles and metadata can be added with no technology intervention. It may be driven by pattern identification. For example, technology builds may only be required if the capture process requires a unique pattern not previously identified.

In one embodiment, the search capability may be a heuristic hierarchy search that seamlessly integrates with pre-identified taxonomy, client reference data, content data, relationship data and other “golden” sources to make searches significantly more meaningful. It may provide a single search entitlement structure and single module user access, and a seamless search mechanism across any document type. In one embodiment, the search engine may use “search engine” behavior and can search across multiple document repositories. A common document model may facilitate searching legacy data models.

In one embodiment, a mechanism to publish document data to any consumer for digital consumption or reporting is disclosed. The publishing mechanism may not change when new documents and metadata are introduced, and may be based on an extendible data model that eliminates need for new models.

In one embodiment, an end-to-end service oriented architecture is disclosed. It may comprise a framework that can seamlessly connect core technology, and may enable all workflow participants to receive appropriate entitlements and progress notifications. In one embodiment, an end-to-end logic model may be agnostic to pre-existing core technology, and a framework code may be leveraged for use across any documentation type. It provide a one-stop change framework that flows end-to-end, i.e., is not dependent on individual core component code releases.

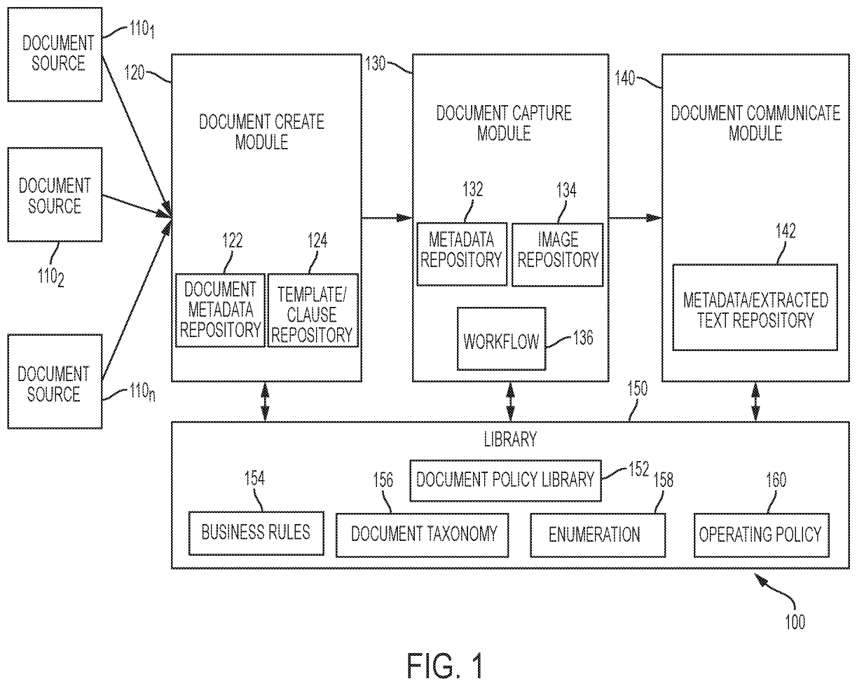

Referring to FIG. 1, a system for document management classification, capture and search is disclosed according to one embodiment. In one embodiment, system 100 may include one or more document source 110₁, 110₂, . . . 110ₙ, document create module 120, document capture module 130, document communicate module 140, and library 150, business rules 152, document taxonomy 154, enumeration 156, and operating policy 158.

In one embodiment, one or more document source 110₁, 110₂, . . . 110ₙ may be any source of documents, including internal sources (e.g., within the organization) and external sources (e.g., outside the organization).

Document create module 120 may perform document creation functions, such as document authoring, document assembly, document negotiation, etc. In one embodiment, document create module 120 may include document metadata repository 122 and template/clause repository 124. Document metadata repository 122 may store metadata that may be associated with a document, and/or metadata that may be added to a document when it is created. Template/clause repository 124 may store documents and/or templates that may be used to create documents.

Document capture module 130 may perform functions associated with the capture and processing of documents, including, for example, document scanning, document digitization, document indexing, document approval, document retention, and relationship identification. In one embodiment document capture module 130 may include metadata repository 132, image repository 134, and workflow 136.

In one embodiment, document communicate module 140 may provide access to the documents and/or data associated with the documents. For example, document communicate module 140 may provide metadata and content searching, reporting (e.g., business objectives), and document distribution. In one embodiment, document communicate module 140 may include metadata and extracted text repository 142.

In one embodiment, one or more interfaces (not shown) may be provided to access documents and or the document contents. Access may be provided, for example, to other processes, to individuals, etc.

In one embodiment, library 150 may contain information that may be accessed by document create module 120, document capture module 130, and document communicate module 140. In one embodiment, library 150 may include document policy library 152, business rule library 154, document taxonomy library 156, enumeration library 158, and operating policy library 160.

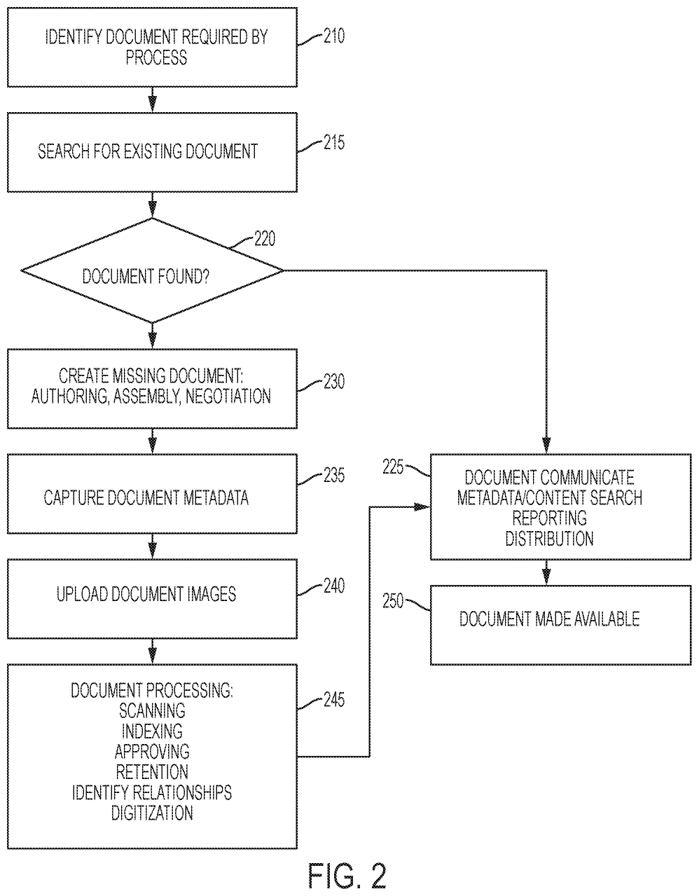

Referring to FIG. 2, a method for document management classification, capture and search is disclosed according to one embodiment.

In step 210, documents that are required by a process, such as a business process, may be identified. In one embodiment, one or more search criteria may be identified. In one embodiment, a user, a process, etc. may provide one or more keywords, identifiers, etc. that may be used to search for a document.

In step 215, the system may search a document repository for one or more document that meets the search criteria.

In step 220, if one or more document that meets the search criteria is found, the process may continue with document communicate in step 225.

If no documents are found, in step 230, a document may be created. In one embodiment, the data for document creation may be provided from a source that is internal to the organization, and/or from a source that is external to the organization.

In one embodiment, documents may be authored, assembled, and negotiated. In one embodiment, a document metadata repository and/or a template clause repository may be used to author and assemble the document. In one embodiment, this may include generation of documents from templates, from user driven questionnaires, etc. Negotiated documents may then be tracked and the final version used for document and data capture.

In one embodiment, document negotiation may be taxonomy-driven and may be based on standard definitions of legal documents and other documents. In one embodiment, pre-defined data profiles may be used for each party to the negotiation so that each party may declare its preferred values and legal terms. These terms may be used as opening terms in the negotiation process.

In one embodiment, the document taxonomy may define the hierarchy of document types and their associated metadata.

In one embodiment, the negotiation process may recognize values or terms that are in agreement and those that differ. In one embodiment, counter proposals may be automatically made.

In one embodiment, simultaneous negotiation may be used, wherein the parties may negotiate at the same time. For example, each party may propose and counter propose groups of data terms. Each group of terms may be approved individually.

In one embodiment, after all terms are approved by both parties, the data may be executed to form a legally binding agreement between the parties.

In one embodiment, documents may be digitally signed.

In step 235, document metadata may be captured. In one embodiment, metadata may be indexed and stored. This may, for example, store core metadata (e.g., metadata that is common to all document types) and extended metadata (e.g., metadata that is document-specific as defined by the taxonomy).

In step 240, document images may be uploaded to, for example, a document capture module. In step 245, the document images may then be scanned, indexed, approved, retained, relationships identified, and digitized.

In one embodiment, digitization may automatically identify, extract, validate, and/or transform document content into machine-readable data and information. Following digitization, machine learning, natural language processing, structured form processing, semi/unstructured directives processing, etc. may be performed.

In one embodiment, this may also provide the capability for document and content storage, automated content extraction (digitization), image acquisition, quality control, workflow, tagging and management.

In step 225, document may be communicated, shared, and/or searched. In one embodiment, this may provide the capability to search for, view, consume, and/or report upon document data.

In one embodiment, this may include metadata and content searching, operational and data reporting, data distribution, and entity relationship-based searching.

In one embodiment, metadata from the documents may flow downstream to credit, financial, operational, risk and other applications for processing, reporting and/or other search purposes.

In step 250, the document may be made available.

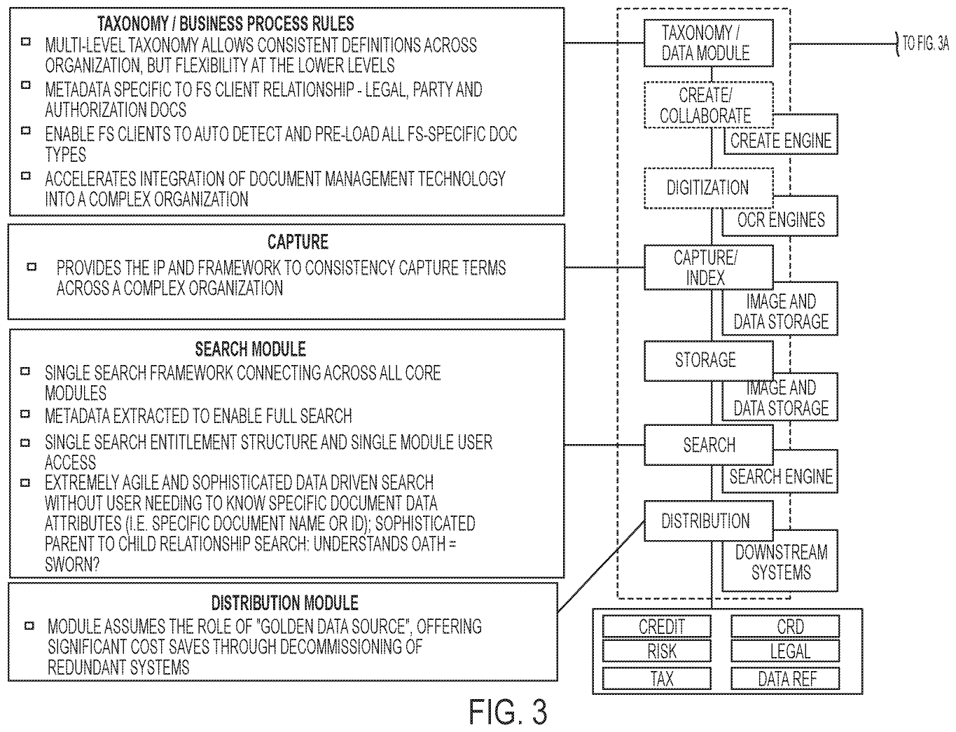

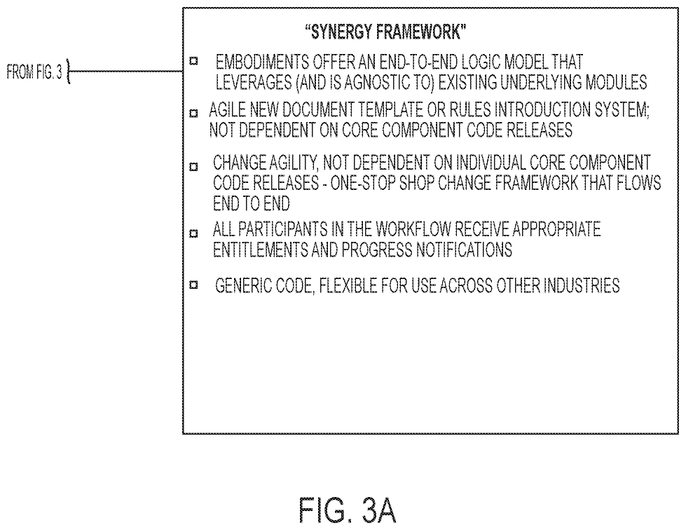

Referring to FIG. 3, a high-level architecture for document management is disclosed according to one embodiment. The architecture may include, for example, a taxonomy/data module, a create/collaborate module, a digitization module, a capture/index module, a storage module, a search module, and a distribution module. In one embodiment, a variety of units within an organization (e.g., for a financial institution, credit, risk, tax, etc.) may search and/or access the data.

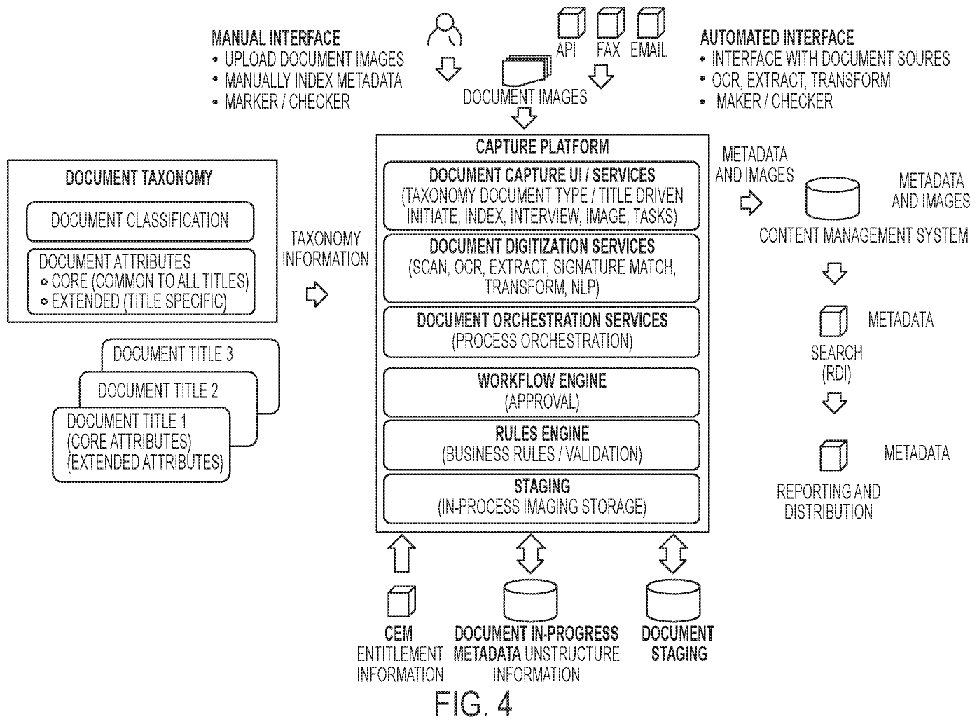

Referring to FIG. 4, an architecture of a document capture platform is disclosed according to one embodiment. In one embodiment, a document taxonomy may be used in conjunction with the capture platform to capture documents, extract metadata and images, and make the metadata available for search, reporting, and distribution.

In one embodiment, the capture platform may be a taxonomy driven platform, and the taxonomy may define document classification, attributes, and business rules about the document metadata.

In one embodiment, the user(s) may specify document metadata after selecting an appropriate document classification and tittle. They may also upload the relevant document images.

In one embodiment, the capture platform may render its user interface based on the taxonomy information it retrieves form the taxonomy system. The user interface may also enforce the business rules contained in the taxonomy system.

In one embodiment, the automated interface may employ an OCR engine to automatically determine the document classification and title, and to extract metadata and enter it in the system on behalf of the user (proposed functionality)

In one embodiment, after the metadata and images have been captured, they may flow to the content management system, and from the content management system, the metadata information may flow into the search engine. The information may be searched and distributed from the search engine.

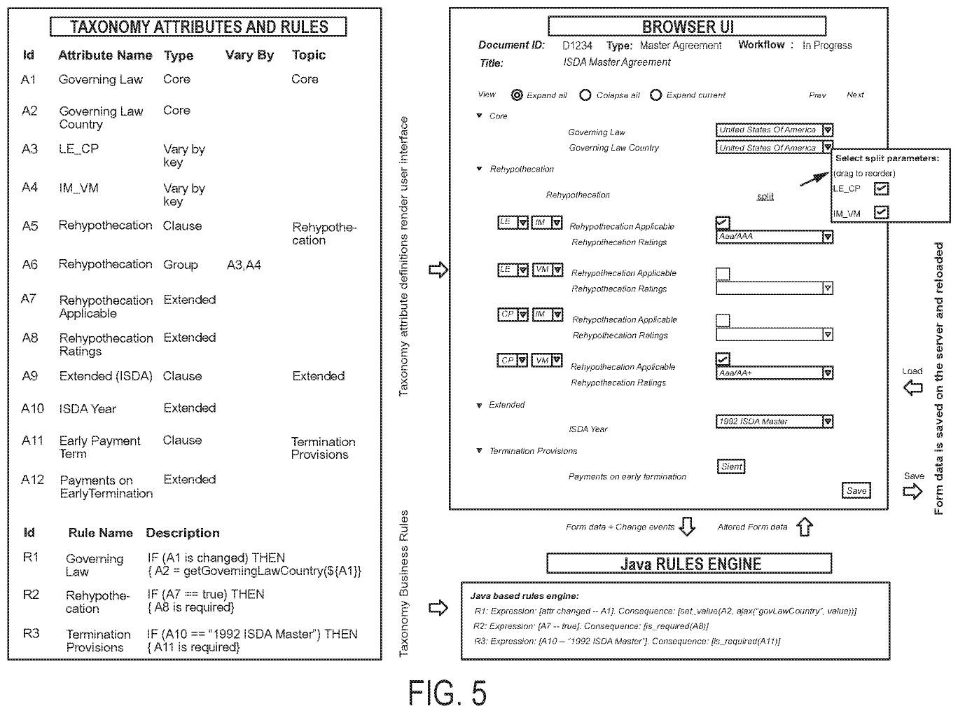

Referring to FIG. 5, an example of a taxonomy is provided according to one embodiment. Note that although FIG. 4 is in the context of a financial institution, it should be noted that this is exemplary only and does not limit the disclosure.

In FIG. 5, the different levels of the taxonomy attribute names, types, variations, and topics are provided. On the right side of FIG. 5, an example of the visualization of the taxonomy via a user interface is provided. Note that topics can be expanded, and drop-down boxes may facilitate entry of attributes.

FIG. 5 illustrates a sample (partial) taxonomy attribute information and sample (partial) rules information, as well as a rendition of taxonomy attribute information into the user interface.

FIG. 5 also illustrates that data points can be split into additional data points by the use of certain other data points (these are called “vary by” data points)

In one embodiment, the information captured by the user interface may be validated by sending it to a server side rules engine. The rules engine may receive the business rules from the taxonomy definition.

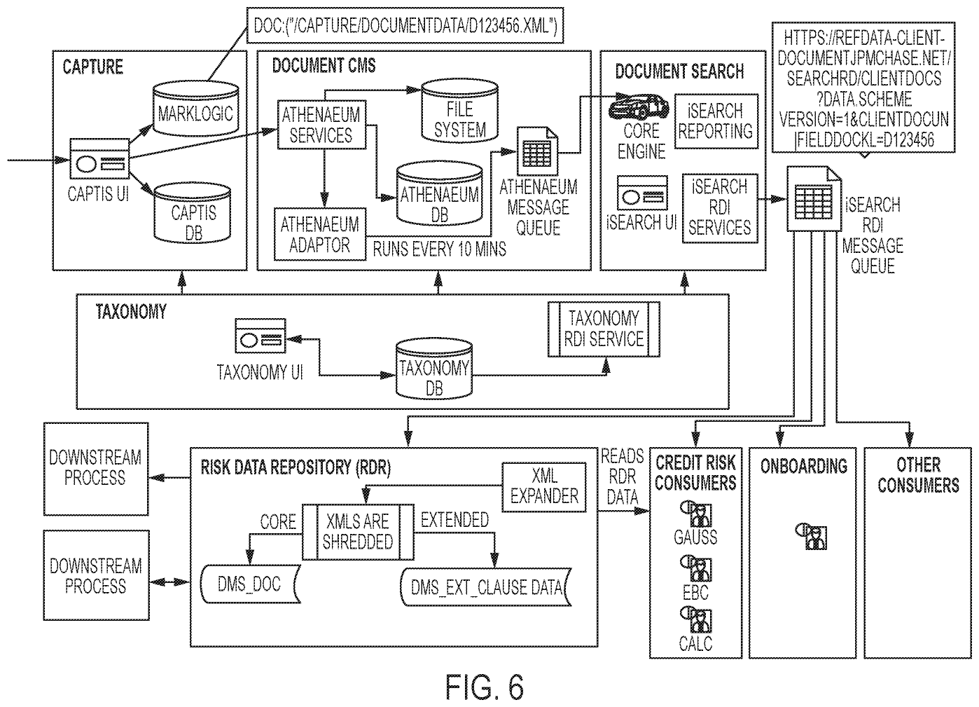

Referring to FIG. 6, an end-to-end process flow of a capture process is disclosed according to one embodiment. A document may be captured in the capture image, and metadata may be made available to the search process.

In one embodiment, the taxonomy system may define document classifications and attributes for the various document titles that the capture system processes. The capture system allows document metadata to be indexed (captures) and the document images to be uploaded. It may store the document metadata in an internal database, and may execute document approval workflows in order to validate the document metadata information.

It may then send the approved document images and the document metadata to the document content management system, where the document metadata and the images may be stored following, for example, appropriate retention rules.

From the document management system the document metadata may flow into the search engine. The search engine may be provided with a user interface to facilitate a search for document metadata based on specific data points or the document text. It may also publish document metadata to downstream systems for consumption.

FIG. 6 further illustrates exemplary document metadata consumers spanning credit and risk systems, onboarding systems and other systems. It should be noted that these consumers are exemplary only and others may be used as is necessary and/or desired.

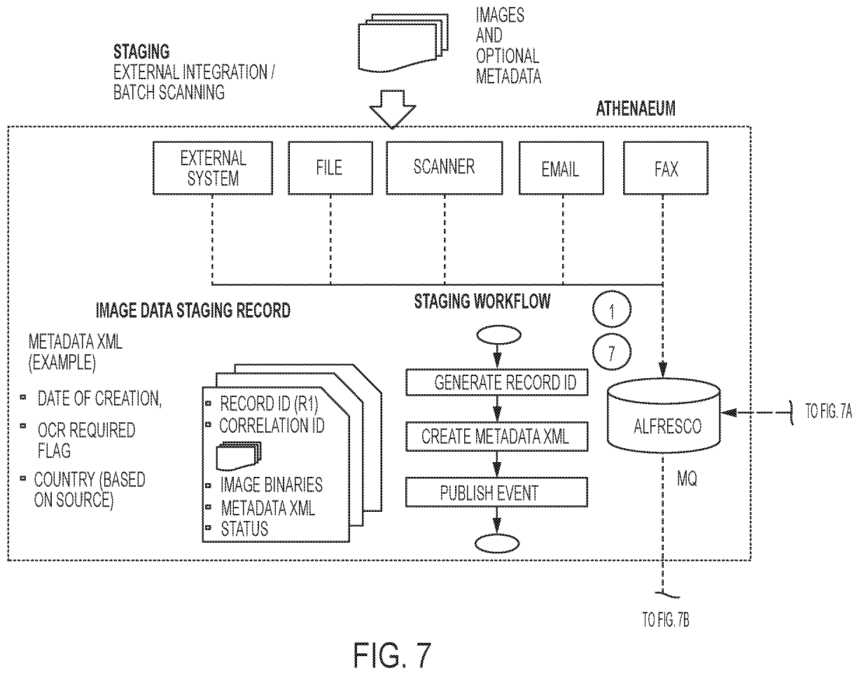

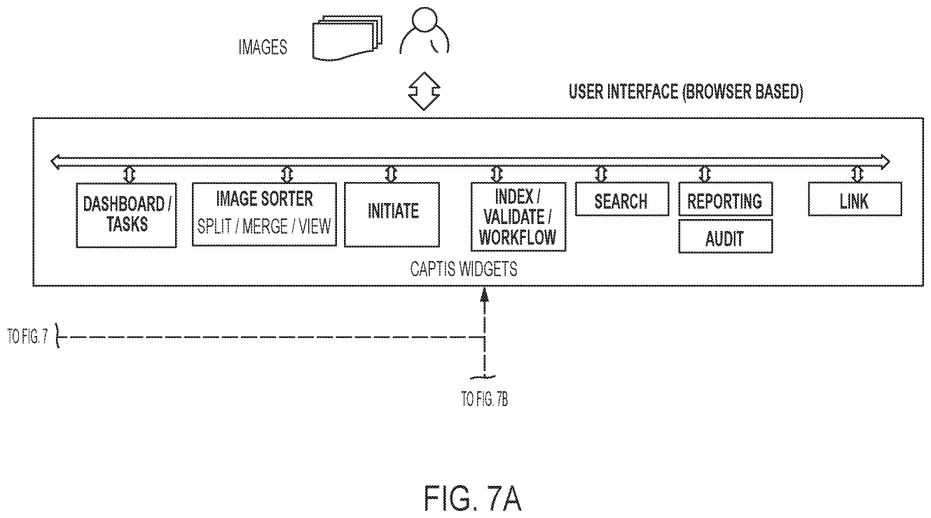

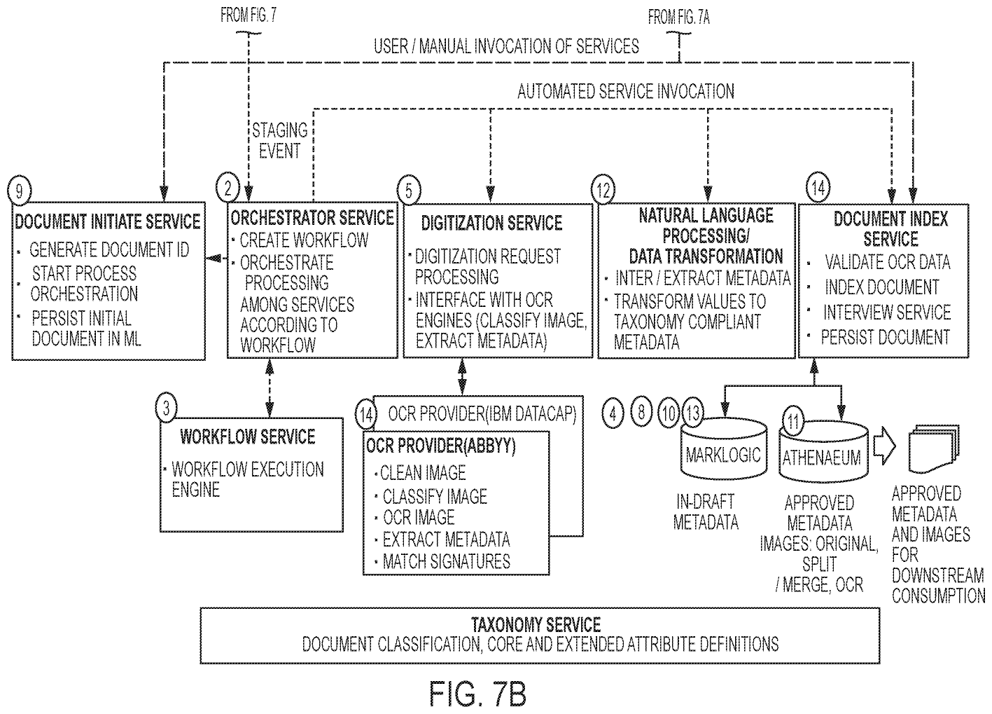

Referring to FIG. 7, an example digitization process is disclosed according to one embodiment. According to one embodiment, the system may receive digital copies of documents from a variety of sources. The process flow proceeds as follows: (1) the digital images may be stored on a staging area, and the staging area may assemble preliminary metadata regarding the digital images. It may then send an event comprising the initial metadata and the location of the digital image to the orchestration engine; (2) the orchestration service receives staging event; (3) an orchestration workflow may be created which may dictate the further invocation of services; (4) a staging request may be saved in a database, such as a MarkLogic repository; (5) digitization service may be invoked and may extract content from the digital image and convert the image into a machine readable format; (6) the image may be processed by optical character recognition and may be classified, metadata may be extracted; (7) individual document images may be saved in staging; (8) an updated request XML may be saved in a database, such as a MarkLogic repository; (9) an initiate service may create documents classified by OCR with raw OCR metadata; (10) initiated documents may be saved; (11) individual document images saved in, for example, a centralized repository (e.g., Athenaeum); (12) Raw OCR metadata may be transformed into taxonomy-defined attributes for each document; (13) each document may be updated with transformed core and extended metadata; (14) documents may be made available for further approval in, for example, a metadata user interface.

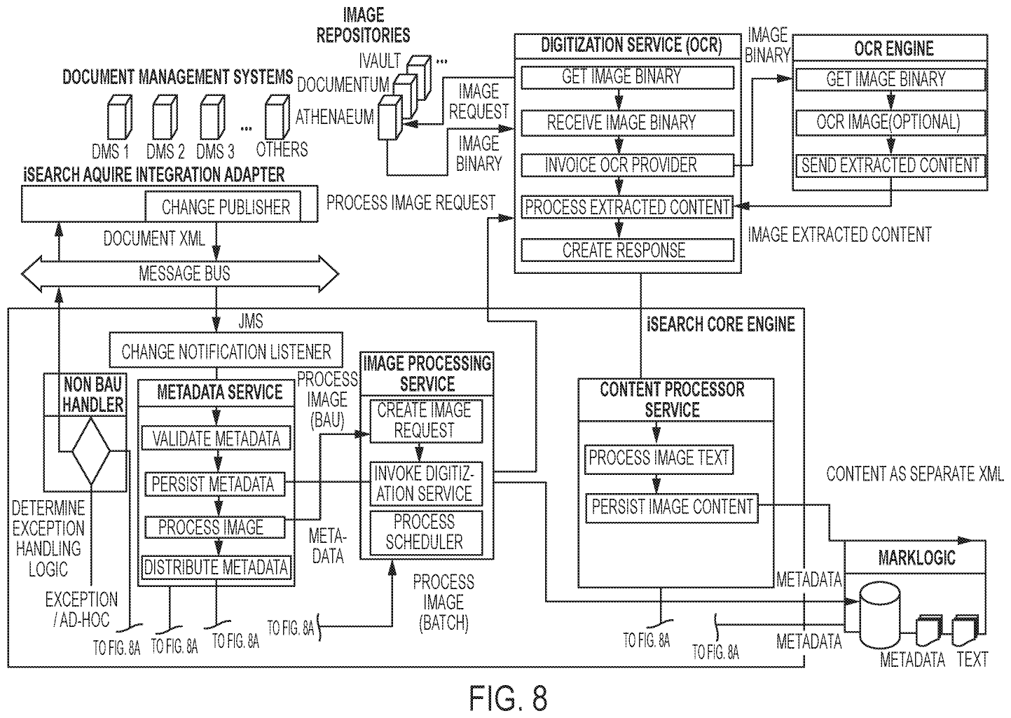

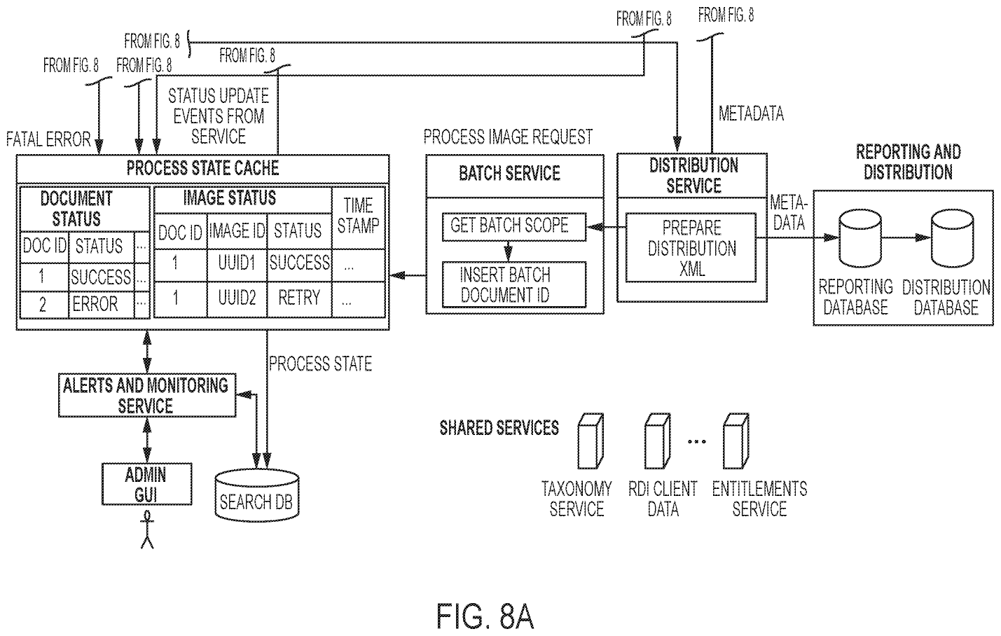

Referring to FIG. 8, a search architecture is provided according to one embodiment.

In one embodiment, the search engine may receive input from one or more document management system (DMS). In one embodiment, interfacing DMS may be required to send metadata information adhering to the structure of the taxonomy definition.

The search engine may receive its messages from, for example, a message bus. The message may only contain metadata, and not the actual images themselves. The metadata may indicate where the actual images reside and an image identifier.

The change notification listener may be invoked when a new message arrives. It may then invoke the metadata service.

The metadata service may validate the incoming message and may persist the metadata in to the search engine database.

The incoming message may indicate if the document image(s) related to the message require processing to extract content from them and to index the content to be searchable. If so, the search engine may invoke the image processing service which may invoke the digitization service to retrieve the image and extract its text content.

The extracted text content may be sent to the content processor service which indexes the text content as searchable text content.

After storing the incoming message, the metadata service may invoke the distribution service to distribute information.

In one embodiment, the search engine may use a NoSQL database to store metadata and image text content to make it searchable and distributable.

The search engine may further include a batch service to automate image content extraction and indexing for images whose content was not extracted at the time of message ingestion.

The process state cache may track the state of message flow within the various services and may also track the state of text content processing for the various images.

Hereinafter, general aspects of implementation of the systems and methods of the invention will be described.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a cardholder or cardholders of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “cardholder interfaces” may be utilized to allow a cardholder to interface with the processing machine or machines that are used to implement the invention. As used herein, a cardholder interface includes any hardware, software, or combination of hardware and software used by the processing machine that allows a cardholder to interact with the processing machine. A cardholder interface may be in the form of a dialogue screen for example. A cardholder interface may also include any of a mouse, touch screen, keyboard, keypad, voice reader, voice recognizer, dialogue screen, menu box, list, checkbox, toggle switch, a pushbutton or any other device that allows a cardholder to receive information regarding the operation of the processing machine as it processes a set of instructions and/or provides the processing machine with information. Accordingly, the cardholder interface is any device that provides communication between a cardholder and a processing machine. The information provided by the cardholder to the processing machine through the cardholder interface may be in the form of a command, a selection of data, or some other input, for example.

As discussed above, a cardholder interface is utilized by the processing machine that performs a set of instructions such that the processing machine processes data for a cardholder. The cardholder interface is typically used by the processing machine for interacting with a cardholder either to convey information or receive information from the cardholder. However, it should be appreciated that in accordance with some embodiments of the system and method of the invention, it is not necessary that a human cardholder actually interact with a cardholder interface used by the processing machine of the invention. Rather, it is also contemplated that the cardholder interface of the invention might interact, i.e., convey and receive information, with another processing machine, rather than a human cardholder. Accordingly, the other processing machine might be characterized as a cardholder. Further, it is contemplated that a cardholder interface utilized in the system and method of the invention may interact partially with another processing machine or processing machines, while also interacting partially with a human cardholder.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

1. A method for document creation, comprising:
at least one computer processor receiving an identification of a document type;
the at least one computer processor receiving content data wherein a source of the content data comprises a database internal to an organization and one or more external sources;
the at least one computer processor retrieving a taxonomy for the document type wherein the taxonomy defines a hierarchy of document types and metadata associated with the document types, and further wherein the taxonomy represents a common consistent document ontology across various parts of an organization;
the at least one computer processor receiving a plurality of selections for document attributes based on the taxonomy;
the at least one computer processor creating a document from one or more templates stored in a template repository based on the plurality of selections for document attributes and the content data;
the at least one computer processor negotiating the created document, wherein the document negotiation is taxonomy driven and based on standard definitions for a given document type, and wherein the document negotiation recognizes values of terms that differ and automatically provides at least one counterproposal;
the at least one computer processor extracting, indexing, and storing metadata from the negotiated document, wherein the metadata includes core metadata relevant to all document types and extended metadata that is document specific as defined by the taxonomy;
the at least one computer processor digitizing the negotiated document, wherein the digitization includes automatically identifying, extracting, validating, and transforming document content into machine-readable data; and
the at least one computer processor implementing a search and distribution engine configured to
provide a search API for integration into one or more software applications; and
output, as a search result, Extensible Markup Language of a page matching a relevant document.

2. A system for document management, comprising:
a memory; and
at least one computer processor programmed to perform the following:
receive content data wherein the source of the content data comprises a database internal to an organization and one or more external sources;
using a document create module, create a document using a document taxonomy from a document taxonomy library, a document metadata repository, and a document template repository that stores a plurality of document templates, and negotiate the created document, wherein the document negotiation is taxonomy driven and based on standard definitions for a given document type, and wherein the document negotiation recognizes values of terms that differ and automatically provides at least one counterproposal;
using a document capture module, extract, index, and store metadata from the negotiated document based on a document taxonomy associated with the document, wherein the metadata includes core metadata relevant to all document types and extended metadata that is document specific as defined by the taxonomy;
using the document capture module, digitize the negotiated document; and
using a document communicate module, store the extracted metadata from the document in an extracted metadata repository and make the digitized negotiated document available for communication, searching, and sharing;
wherein the document taxonomy library comprises a plurality of document taxonomies and wherein the document taxonomies define a hierarchy of document types and metadata associated with the document types, and further wherein the taxonomies represent a common consistent document ontology across various parts of an organization;
wherein the document create module comprises a document metadata repository and a document template repository;
wherein the document capture module comprises a metadata repository, an image repository, and a document capture workflow; and
wherein the document communicate module comprises an extracted metadata repository, provides a search API for integration into one or more software applications, and outputs, as a search result, Extensible Markup Language of a page matching a relevant document.

3. The system of claim 2, wherein the document communicate module provides document searching using the extracted metadata.

4. The system of claim 2, further comprising:
a downstream process that interacts with the document communicate module.

5. A method for document metadata capture, comprising:
at least one computer processor receiving an identification of a document required by a business process;
the at least one computer processor interpreting and rendering, on a display, a user interface related to the document;
the at least one computer processor storing metadata related to the document;
the at least one computer processor splitting a first list of data points based on a second list of data points wherein the splitting is based on a stored description of how data points can be split;
the at least one computer processor identifying at least one relationship in the document;
the at least one computer processor tagging each data point of the first list of data points with a unique repeat that describes the context of the split;
the at least one computer processor communicating the document and metadata to at least one of a second computer process, a process, a storage, and an individual.

6. The method of claim 1, wherein digitizing the document comprises performing optical character recognition on the document to extract machine-readable data.

7. The method of claim 1, wherein the content data comprises data from user driven questionnaires.

8. The method of claim 1, wherein the metadata extracted from the document comprises:
core metadata that is common to all document types; and
extended metadata that is document-specific.

9. The method of claim 1, further comprising:
a metadata repository that stores metadata; and
wherein at least some of the stored metadata is associated with the created document.

10. The method of claim 1, further comprising:
a template repository that stores document templates; and
wherein the document is created using one of the document templates.

11. The method of claim 10 wherein a document template is a prior version of a negotiated document and the created document is counter proposal.

12. The system of claim 2, wherein digitizing the document comprises performing optical character recognition on a scanned document to extract machine-readable data.

13. The system of claim 2, wherein the content data comprises data from user driven questionnaires.

14. The system of claim 2, wherein the metadata extracted from the document comprises:
core metadata that is common to all document types; and
extended metadata that is document-specific.

15. (canceled)

16. The system of claim 2, wherein a set of metadata from the document metadata repository is associated with the content data when the document is created.

17. The system of claim 2, wherein a template from the document template repository is used to create the document.

18. The system of claim 2, wherein the document communicate module allows for operational and data reporting and data distribution.

19. The system of claim 2, wherein the document communicate module allows for entity relationship-based searching.

20. The system of claim 3, wherein the document searching is in the form of an API that is integrated into one or more other applications.
